(19) United States
(12) Patent Application Publication
(10) Pub. No.: US 2025/0155583 A1
(43) Pub. Date: May 15, 2025

(54) SYSTEMS AND METHODS FOR LOCATION VERIFICATION IN NON TERRESTRIAL NETWORK

(71) Applicant: ZTE CORPORATION, Shenzhen (CN)

(72) Inventors: Fangyu CUI, Shenzhen (CN); Nan ZHANG, Shenzhen (CN); Wei CAO, Shenzhen (CN); Jianwu DOU, Shenzhen (CN)

(73) Assignee: ZTE CORPORATION, Shenzhen (CN)

(21) Appl. No.: 19/020,705

(22) Filed: Jan. 14, 2025

Related U.S. Application Data
(63) Continuation of application No. PCT/CN2023/073777, filed on Jan. 30, 2023.

(51) Int. Cl. G01S 19/25

(52) U.S. Cl. CPC G01S 19/252; G01S 19/256

(57) ABSTRACT

Presented are systems and methods for location verification in non-terrestrial networks (NTNs). A core network may receive assistance information from at least one node of a radio access network (RAN), to perform location verification of a wireless communication device of the RAN.

### CROSS-REFERENCE TO RELATED APPLICATION

This application claims the benefit of priority under 35 U.S.C. § 120 as a continuation of PCT Patent Application No. PCT/CN2023/073777, filed on Jan. 30, 2023, the disclosure of which is incorporated herein by reference in its entirety.

### TECHNICAL FIELD

The disclosure relates generally to wireless communications, including but not limited to systems and methods for location verification in non-terrestrial network (NTN).

### BACKGROUND

The standardization organization Third Generation Partnership Project (3GPP) is currently in the process of specifying a new Radio Interface called 5G New Radio (5G NR) as well as a Next Generation Packet Core Network (NG-CN or NGC). The 5G NR will have three main components: a 5G Access Network (5G-AN), a 5G Core Network (5GC), and a User Equipment (UE). In order to facilitate the enablement of different data services and requirements, the elements of the 5GC, also called Network Functions, have been simplified with some of them being software based, and some being hardware based, so that they could be adapted according to need.

### SUMMARY

The example embodiments disclosed herein are directed to solving the issues relating to one or more of the problems presented in the prior art, as well as providing additional features that will become readily apparent by reference to the following detailed description when taken in conjunction with the accompany drawings. In accordance with various embodiments, example systems, methods, devices and computer program products are disclosed herein. It is understood, however, that these embodiments are presented by way of example and are not limiting, and it will be apparent to those of ordinary skill in the art who read the present disclosure that various modifications to the disclosed embodiments (e.g., including combining features from various disclosed examples, embodiments and/or implementations) can be made while remaining within the scope of this disclosure.

At least one aspect is directed to a system, method, apparatus, or a computer-readable medium of the following. A core network may receive assistance information from at least one node (e.g., a UE and/or a BS) of a radio access network (RAN), to perform location verification of a wireless communication device (e.g., a UE) of the RAN. In some embodiments, the assistance information may include ephemeris information of a satellite. The core network may perform the location verification of the wireless communication device using the assistance information.

In some embodiments, the at least one node may include a base station. The assistance information may comprise first assistance information. The first assistance information may comprise at least one of: ephemeris information of at least one satellite; common timing advance (TA) parameters of the at least one satellite; at least one of: an angle of arrival (AoA) or an angle of departure (AoD) at the at least one satellite; an estimation of a location of the wireless communication device by the base station; at least one parameter of TA reported by the wireless communication device; assistance information reported by the wireless communication device to the base station, comprising at least one of: the location of the wireless communication device, a mobility status of the wireless communication device, a trajectory of the wireless communication device, a measurement of reference signal received power (RSRP) or reference signal received quality (RSRQ) of a serving cell or at least one neighbor cell, ephemeris information applied at the wireless communication device, or common TA parameters; time information corresponding to one or more of foregoing information; at least one of a cell identifier (ID) or a beam ID corresponding to one or more of the foregoing information; or a beam ID corresponding to at least one defined measurement result.

In some embodiments, the assistance information can be indicated via a next generation (NG) interface or an N2 interface. The core network may send a signaling to trigger or request reporting of the first assistance information (e.g., send periodically, or once (to trigger a periodic series of reporting)). The signaling can be sent using new radio positioning protocol A (NRPPa) protocol. The signaling can be sent via a next generation (NG) interface or an N2 interface.

In some embodiments, the core network may receive the assistance information reported by the wireless communication device to the base station, in a defined container message from the base station. The at least one node may include the wireless communication device. The assistance information may comprise second assistance information. The second assistance information may comprise at least one of: timing advance (TA) applied at the wireless communication device; the ephemeris information applied at the wireless communication device (e.g., applied for UL pre-compensation); common timing advance (TA) parameters applied at the wireless communication device; a location of the wireless communication device; at least one of a mobility status or a trajectory of the wireless communication device; a measurement of reference signal received power (RSRP) or reference signal received quality (RSRQ) of a serving cell or at least one neighbor cell; time information corresponding to one or more of foregoing information; at least one of a cell identifier (ID) or a beam ID corresponding to one or more of the foregoing information; or a beam ID corresponding to at least one defined measurement result. The assistance information can be indicated via an N1 interface. The core network may send a signaling to trigger or request reporting of the second assistance information to the wireless communication device. The signaling can be sent using new radio positioning protocol (NRPP) protocol. The signaling can be sent via an N1 interface.

In some embodiments, the core network may send a first signaling to trigger or request reporting of the assistance information to the base station. The base station may send a second signaling to the wireless communication device to trigger or request the reporting of the assistance information. The first signaling can be sent via a next generation (NG) interface or an N2 interface. The second signaling can be sent via an Uu interface.

In some embodiments, the at least one node of the RAN may comprise a base station. The wireless communication device may send at least one location verification measurement result to the base station. The core network may receive the at least one location verification measurement result from the base station. The at least one location verification measurement result may form at least a part of the assistance information.

In some embodiments, the at least one location verification measurement result may comprise at least one of: difference in measurements of round-trip times (RTTs) or between receive and transmit (Rx-Tx) times; at least one measurement of reference signal time difference (RSTD); at least one measurement of relative time of arrival (RTOA); a timestamp or time information of at least one of foregoing measurements; or at least one of a cell identifier (ID) or a beam ID corresponding to one or more of the foregoing measurements. The core network may send a first signaling to trigger or request reporting of the at least one defined measurement result to the base station. The core network may cause the base station to send a second signaling to the wireless communication device to trigger or request the reporting of the at least one defined measurement result. The first signaling may comprise at least one of: a radio resource control (RRC) signaling, a medium access control control element (MAC CE) signaling, or a downlink control information (DCI) signaling. The RSTD or the RTOA may correspond to a time difference between times of arrival (TOAs) corresponding to a same transmit-receive point (TRP) at different time instances. The RSTD or the RTOA may correspond to a time difference between times of arrival (TOAs) corresponding to a same transmit-receive point (TRP) at different time instances, minus a time difference between reference signal transmissions.

In some embodiments, at least one node (e.g., a UE and/or a BS) of a radio access network (RAN) may send assistance information to a core network to perform location verification of a wireless communication device (e.g., a UE) of the RAN.

### BRIEF DESCRIPTION OF THE DRAWINGS

Various example embodiments of the present solution are described in detail below with reference to the following figures or drawings. The drawings are provided for purposes of illustration only and merely depict example embodiments of the present solution to facilitate the reader's understanding of the present solution. Therefore, the drawings should not be considered limiting of the breadth, scope, or applicability of the present solution. It should be noted that for clarity and ease of illustration, these drawings are not necessarily drawn to scale.

FIG. 1 illustrates an example cellular communication network in which techniques disclosed herein may be implemented, in accordance with an embodiment of the present disclosure;

FIG. 2 illustrates a block diagram of an example base station and a user equipment device, in accordance with some embodiments of the present disclosure;

FIG. 3 illustrates an example non-terrestrial network (NTN), in accordance with some embodiments of the present disclosure;

FIG. 4 illustrates an example multi-cell round trip time (multi-RTT) method, in accordance with some embodiments of the present disclosure;

FIG. 5 illustrates an example of positioning by a single satellite/aerial vehicle, in accordance with some embodiments of the present disclosure; and

FIG. 6 illustrates a flow diagram for location verification in a non-terrestrial network (NTN), in accordance with an embodiment of the present disclosure.

### DETAILED DESCRIPTION

### 1. Mobile Communication Technology and Environment

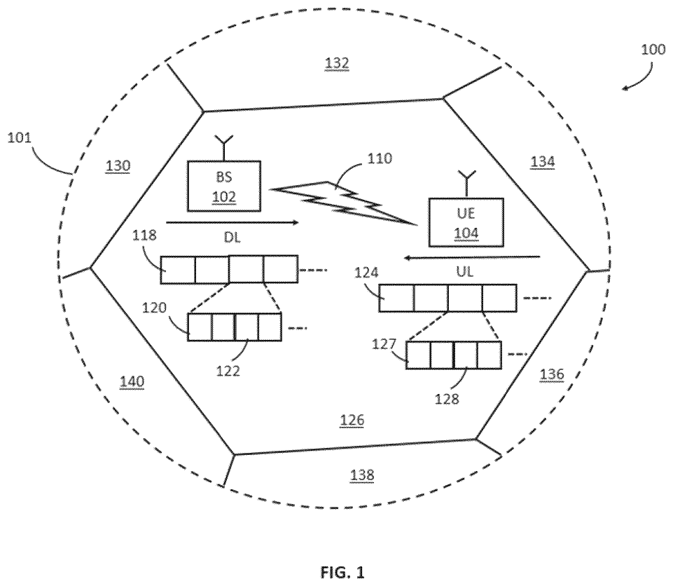

FIG. 1 illustrates an example wireless communication network, and/or system, 100 in which techniques disclosed herein may be implemented, in accordance with an embodiment of the present disclosure. In the following discussion, the wireless communication network 100 may be any wireless network, such as a cellular network or a narrowband Internet of things (NB-IoT) network, and is herein referred to as “network 100.” Such an example network 100 includes a base station 102 (hereinafter “BS 102”; also referred to as wireless communication node) and a user equipment device 104 (hereinafter “UE 104”; also referred to as wireless communication device) that can communicate with each other via a communication link 110 (e.g., a wireless communication channel), and a cluster of cells 126, 130, 132, 134, 136, 138 and 140 overlaying a geographical area 101. In FIG. 1, the BS 102 and UE 104 are contained within a respective geographic boundary of cell 126. Each of the other cells 130, 132, 134, 136, 138 and 140 may include at least one base station operating at its allocated bandwidth to provide adequate radio coverage to its intended users.

For example, the BS 102 may operate at an allocated channel transmission bandwidth to provide adequate coverage to the UE 104. The BS 102 and the UE 104 may communicate via a downlink radio frame 118, and an uplink radio frame 124 respectively. Each radio frame 118/124 may be further divided into sub-frames 120/127 which may include data symbols 122/128. In the present disclosure, the BS 102 and UE 104 are described herein as non-limiting examples of “communication nodes,” generally, which can practice the methods disclosed herein. Such communication nodes may be capable of wireless and/or wired communications, in accordance with various embodiments of the present solution.

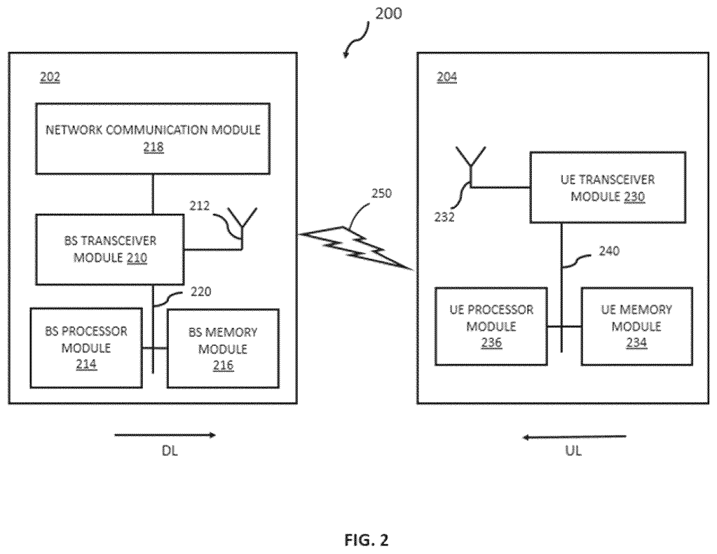

FIG. 2 illustrates a block diagram of an example wireless communication system 200 for transmitting and receiving wireless communication signals (e.g., OFDM/OFDMA signals) in accordance with some embodiments of the present solution. The system 200 may include components and elements configured to support known or conventional operating features that need not be described in detail herein. In one illustrative embodiment, system 200 can be used to communicate (e.g., transmit and receive) data symbols in a wireless communication environment such as the wireless communication environment 100 of FIG. 1, as described above.

System 200 generally includes a base station 202 (hereinafter “BS 202”) and a user equipment device 204 (hereinafter “UE 204”). The BS 202 includes a BS (base station) transceiver module 210, a BS antenna 212, a BS processor module 214, a BS memory module 216, and a network communication module 218, each module being coupled and interconnected with one another as necessary via a data communication bus 220. The UE 204 includes a UE (user equipment) transceiver module 230, a UE antenna 232, a UE memory module 234, and a UE processor module 236, each module being coupled and interconnected with one another as necessary via a data communication bus 240. The BS 202 communicates with the UE 204 via a communication channel 250, which can be any wireless channel or other medium suitable for transmission of data as described herein.

As would be understood by persons of ordinary skill in the art, system 200 may further include any number of modules other than the modules shown in FIG. 2. Those skilled in the art will understand that the various illustrative blocks, modules, circuits, and processing logic described in connection with the embodiments disclosed herein may be implemented in hardware, computer-readable software, firmware, or any practical combination thereof. To clearly illustrate this interchangeability and compatibility of hardware, firmware, and software, various illustrative components, blocks, modules, circuits, and steps are described generally in terms of their functionality. Whether such functionality is implemented as hardware, firmware, or software can depend upon the particular application and design constraints imposed on the overall system. Those familiar with the concepts described herein may implement such functionality in a suitable manner for each particular application, but such implementation decisions should not be interpreted as limiting the scope of the present disclosure

In accordance with some embodiments, the UE transceiver 230 may be referred to herein as an “uplink” transceiver 230 that includes a radio frequency (RF) transmitter and a RF receiver each comprising circuitry that is coupled to the antenna 232. A duplex switch (not shown) may alternatively couple the uplink transmitter or receiver to the uplink antenna in time duplex fashion. Similarly, in accordance with some embodiments, the BS transceiver 210 may be referred to herein as a “downlink” transceiver 210 that includes a RF transmitter and a RF receiver each comprising circuitry that is coupled to the antenna 212. A downlink duplex switch may alternatively couple the downlink transmitter or receiver to the downlink antenna 212 in time duplex fashion. The operations of the two transceiver modules 210 and 230 may be coordinated in time such that the uplink receiver circuitry is coupled to the uplink antenna 232 for reception of transmissions over the wireless transmission link 250 at the same time that the downlink transmitter is coupled to the downlink antenna 212. Conversely, the operations of the two transceivers 210 and 230 may be coordinated in time such that the downlink receiver is coupled to the downlink antenna 212 for reception of transmissions over the wireless transmission link 250 at the same time that the uplink transmitter is coupled to the uplink antenna 232. In some embodiments, there is close time synchronization with a minimal guard time between changes in duplex direction.

The UE transceiver 230 and the base station transceiver 210 are configured to communicate via the wireless data communication link 250, and cooperate with a suitably configured RF antenna arrangement 212/232 that can support a particular wireless communication protocol and modulation scheme. In some illustrative embodiments, the UE transceiver 210 and the base station transceiver 210 are configured to support industry standards such as the Long Term Evolution (LTE) and emerging 5G standards, and the like. It is understood, however, that the present disclosure is not necessarily limited in application to a particular standard and associated protocols. Rather, the UE transceiver 230 and the base station transceiver 210 may be configured to support alternate, or additional, wireless data communication protocols, including future standards or variations thereof.

In accordance with various embodiments, the BS 202 may be an evolved node B (eNB), a serving eNB, a target eNB, a femto station, or a pico station, for example. In some embodiments, the UE 204 may be embodied in various types of user devices such as a mobile phone, a smart phone, a personal digital assistant (PDA), tablet, laptop computer, wearable computing device, etc. The processor modules 214 and 236 may be implemented, or realized, with a general purpose processor, a content addressable memory, a digital signal processor, an application specific integrated circuit, a field programmable gate array, any suitable programmable logic device, discrete gate or transistor logic, discrete hardware components, or any combination thereof, designed to perform the functions described herein. In this manner, a processor may be realized as a microprocessor, a controller, a microcontroller, a state machine, or the like. A processor may also be implemented as a combination of computing devices, e.g., a combination of a digital signal processor and a microprocessor, a plurality of microprocessors, one or more microprocessors in conjunction with a digital signal processor core, or any other such configuration.

Furthermore, the steps of a method or algorithm described in connection with the embodiments disclosed herein may be embodied directly in hardware, in firmware, in a software module executed by processor modules 214 and 236, respectively, or in any practical combination thereof. The memory modules 216 and 234 may be realized as RAM memory, flash memory, ROM memory, EPROM memory, EEPROM memory, registers, a hard disk, a removable disk, a CD-ROM, or any other form of storage medium known in the art. In this regard, memory modules 216 and 234 may be coupled to the processor modules 210 and 230, respectively, such that the processors modules 210 and 230 can read information from, and write information to, memory modules 216 and 234, respectively. The memory modules 216 and 234 may also be integrated into their respective processor modules 210 and 230. In some embodiments, the memory modules 216 and 234 may each include a cache memory for storing temporary variables or other intermediate information during execution of instructions to be executed by processor modules 210 and 230, respectively. Memory modules 216 and 234 may also each include non-volatile memory for storing instructions to be executed by the processor modules 210 and 230, respectively.

The network communication module 218 generally represents the hardware, software, firmware, processing logic, and/or other components of the base station 202 that enable bi-directional communication between base station transceiver 210 and other network components and communication nodes configured to communication with the base station 202. For example, network communication module 218 may be configured to support internet or WiMAX traffic. In a typical deployment, without limitation, network communication module 218 provides an 802.3 Ethernet interface such that base station transceiver 210 can communicate with a conventional Ethernet based computer network. In this manner, the network communication module 218 may include a physical interface for connection to the computer network (e.g., Mobile Switching Center (MSC)). The terms “configured for,” “configured to” and conjugations thereof, as used herein with respect to a specified operation or function, refer to a device, component, circuit, structure, machine, signal, etc., that is physically constructed, programmed, formatted and/or arranged to perform the specified operation or function.

The Open Systems Interconnection (OSI) Model (referred to herein as, “open system interconnection model”) is a conceptual and logical layout that defines network communication used by systems (e.g., wireless communication device, wireless communication node) open to interconnection and communication with other systems. The model is broken into seven subcomponents, or layers, each of which represents a conceptual collection of services provided to the layers above and below it. The OSI Model also defines a logical network and effectively describes computer packet transfer by using different layer protocols. The OSI Model may also be referred to as the seven-layer OSI Model or the seven-layer model. In some embodiments, a first layer may be a physical layer. In some embodiments, a second layer may be a Medium Access Control (MAC) layer. In some embodiments, a third layer may be a Radio Link Control (RLC) layer. In some embodiments, a fourth layer may be a Packet Data Convergence Protocol (PDCP) layer. In some embodiments, a fifth layer may be a Radio Resource Control (RRC) layer. In some embodiments, a sixth layer may be a Non Access Stratum (NAS) layer or an Internet Protocol (IP) layer, and the seventh layer being the other layer.

Various example embodiments of the present solution are described below with reference to the accompanying figures to enable a person of ordinary skill in the art to make and use the present solution. As would be apparent to those of ordinary skill in the art, after reading the present disclosure, various changes or modifications to the examples described herein can be made without departing from the scope of the present solution. Thus, the present solution is not limited to the example embodiments and applications described and illustrated herein. Additionally, the specific order or hierarchy of steps in the methods disclosed herein are merely example approaches. Based upon design preferences, the specific order or hierarchy of steps of the disclosed methods or processes can be re-arranged while remaining within the scope of the present solution. Thus, those of ordinary skill in the art will understand that the methods and techniques disclosed herein present various steps or acts in a sample order, and the present solution is not limited to the specific order or hierarchy presented unless expressly stated otherwise.

### 2. Systems and Methods for Location Verification in Non-Terrestrial Network (NTN)

A Non-Terrestrial Network (NTN) cell can be much larger than a Terrestrial Network (TN) cell. The NTN may cover an area that is more than that of one country. A location of a user equipment (UE) may be known by a network coarsely in order to satisfy service and regulation requirements. The location of a NTN UE may be obtained through Global Navigation Satellite System (GNSS) positioning. However, the GNSS system is independent from a 3GPP communication system and may not be trustable by a network. Therefore, a network verification on a location of a UE can be performed (e.g., as a requirement).

For location verification in NTN, due to the mobility of satellite, some additional information may need to be reported. For example, a satellite can be known by a core network (CN) for verification. However, a location verification can be generated by a control center of satellite and may be directly indicated to a gateway or an evolved node based station (eNB)/next generation node based station (gNB). In such case, a report of ephemeris from an eNB/gNB to a CN may be supported. Similarly, other additional information that is specific for location verification in NTN can be also reported. The report information and trigger procedure are considered in this disclosure.

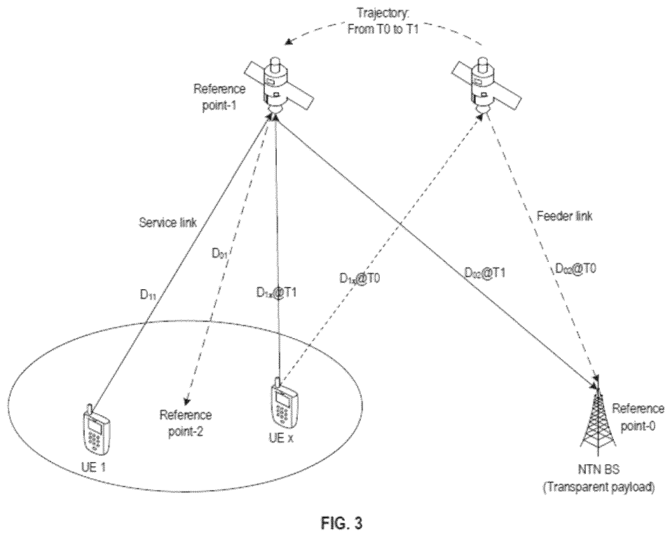

FIG. 3 illustrates an example representation of a NTN, e.g., a transparent NTN. In some embodiments, the link between a UE and a satellite may be a service link. The link between a base station (BS) and a satellite may be a feeder link. The feeder link can be common for all UEs within the same cell.

To verify a location of a UE, a network may perform a trustable positioning (e.g., network based positioning or RAT-dependent positioning) to obtain the location of the UE. There may be multiple RAT-dependent positioning methods for TN, which can be thought/considered trustable. However, in NTN, since a UE may not able to communicate with multiple base stations (e.g., satellites) simultaneously, adaptations on the positioning methods can be investigated.

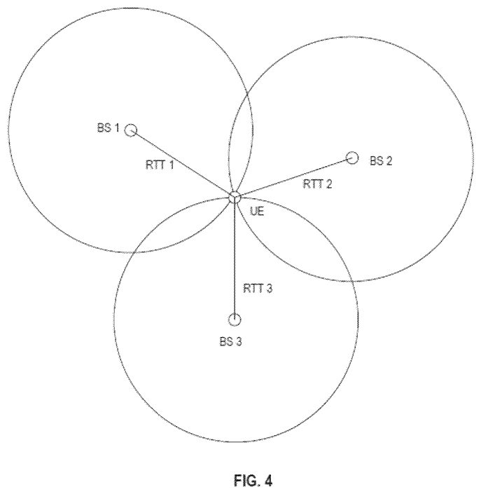

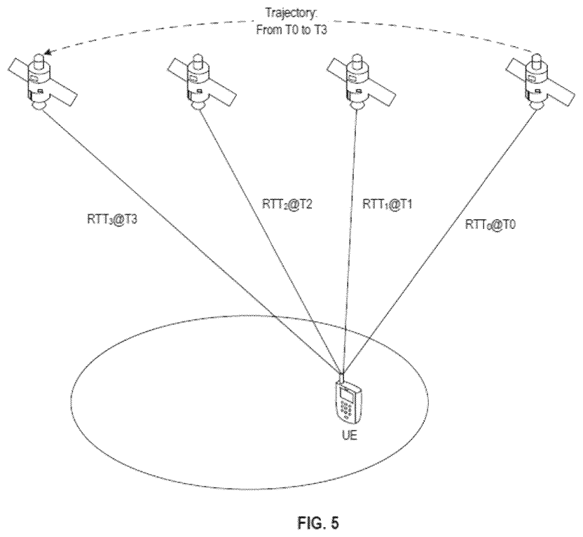

For example, the multi-RTT method as shown in FIG. 4 is a positioning method in a TN. A network may estimate multiple RTTs between a UE and different BSs. Then, the network may be able to determine a distance between the UE and several reference points (e.g., BS locations) and to perform positioning through geometric calculation. In a NTN, there may not be enough satellites available for communication at a same time. FIG. 5 illustrates an example of positioning by using a single satellite/aerial vehicle. Multiple RTTs corresponding to a same BS/satellite/aerial vehicle at different time instants can be estimated in a NTN. Furthermore, the RTT measurement may be replaced by a TA report or a UL RS measurement for positioning.

### Implementation Example 1: Additional Information to be Reported to CN for Location Verification

Information for a location verification of a UE may be obtained/collected in a radio access network (RAN). However, a location service (LCS) can be performed in a core network (CN) by at least one of: an access and mobility management function (AMF), a location management function (LMF), an enhanced serving mobile location center (E-SMLC), or secure user plane location (SUPL) location platform (SLP) modules. Hence, the information used for location verification may be collected in the RAN, and can then be reported to the CN. The report may be either from the UE to the CN or from a gNB/eNB to the CN.

In a terrestrial network (TN) positioning, a report signaling for most of information (e.g., round trip time (RTT) measurement for multi-RTT method) can be supported. However, some assistance information for location verification in NTN may be new and can be additionally defined. For example, in non-terrestrial network (NTN), satellite positions at different time instances can be considered as anchor points for positioning. Ephemeris information of at least one satellite can be known by modules to perform location verification to derive the anchor points. However, the ephemeris information of at least one satellite can be generated by a control center of the at least one satellite, which can be outside of the CN. If the ephemeris information of at least one satellite is indicated to the CN via a certain interface, the CN can perform a single satellite based location verification via an implementation. However, if the ephemeris information is indicated to a gNB/eNB by a control center of the at least one satellite, the CN may not know the ephemeris information of at least one satellite without reports from the RAN. Without ephemeris information of at least one satellite, the CN may not be aware of the positions of anchor nodes and cannot perform positioning. Therefore, a report of ephemeris information of at least one satellite from the eNB/gNB to the CN, which is not included in previous report signaling, can be supported for location verification in NTN.

Some other additional assistance information reported from an eNB/gNB to a CN may be supported for location verification in a NTN, including at least a timing advance (TA) report from a UE to an eNB/gNB, or an angle of arrival (AoA)/angle of departure (AoD) at a satellite. The AoA can be a receiving angle at the satellite for a signal from the UE. The AoD can be a transmitting angle at the satellite for a signal to the UE. For TA, a TA report by a UE to a BS may be supported. However, the reported TA is used for a RAN operation, e.g., Koffset determination. If the TA report is used for location verification, the TA report may be further reported from the BS (e.g., eNB/gNB) to the CN. Common TA parameters may also be reported to the CN to enable a calculation of TA between the UE and the satellite. For an AoA/AoD at a satellite, although UL-AoA and DL-AoD method has been supported in TN positioning, the AoA/AoD report can be performed at the eNB/gNB. The AoA/AoD measurement and report for the satellite may not be considered. Hence, a report of AoA/AoD at a satellite can be a new type of signaling and may be supported for location verification in NTN.

In some embodiments, due to a mobility of the satellite, the above reported information may be valid only within a certain period of time. In order to notify the CN the time corresponding to the reported information, the eNB/gNB may report time information (e.g., a timestamp) along with the assistance information for location verification to the CN.

Based on the above analysis, in order to support location verification in NTN, the eNB/gNB may support a reporting of assistance information to the CN. The assistance information may comprise at least one of: ephemeris information of at least one satellite; common timing advance (TA) parameters of the at least one satellite; at least one of: an angle of arrival (AoA) or an angle of departure (AoD) at the at least one satellite; an estimation of a location of a wireless communication device (e.g., a UE) reported by a base station (e.g., eNB/gNB); at least one parameter of TA reported by the wireless communication device; assistance information reported by the wireless communication device to the base station, comprising at least one of: the location of the wireless communication device, a mobility status of the wireless communication device, a trajectory of the wireless communication device, a measurement of reference signal received power (RSRP) or reference signal received quality (RSRQ) of a serving cell or at least one neighbor cell, ephemeris information applied at the wireless communication device, or common TA parameters; time information corresponding to one or more of foregoing information; at least one of a cell identifier (ID) or a beam ID corresponding to one or more of the foregoing information; or a beam ID corresponding to at least one defined measurement result. The at least one defined measurement result can be RTT/receive and transmit (Rx-Tx) time difference measurements in multi-RTT method, RSTD measurements in DL-time difference of arrival (TDOA) method, or relative time of arrival (RTOA) measurements in UL-TDOA method.

The CN may indicate a trigger/request in a signaling to a eNB/gNB for the report of above information. The trigger/request may be indicated upon once or periodically via a certain signaling. The signaling may be indicated through NR positioning protocol A (NRPPa) protocol. The NRPPa protocol can be a protocol of signaling between a BS and a CN. Moreover, a message may be defined as a container for the assistance information which the eNB/gNB received from the UE. The eNB/gNB may pack the information for location verification reported by the UE (e.g., at least one parameter of TA reported by the UE, or assistance information reported by the UE to the eNB/gNB). The eNB/gNB may report the information to the CN via a signaling message. The time information and/or cell/beam ID corresponding to the assistance information may also be included in the message. The trigger signaling and reporting message may be transmitted using a next generation (NG) interface or N2 interface.

Besides the above assistance information reported from the eNB/gNB to the CN, a new report signaling from the UE to the CN may also be defined. In the above analysis, the information measured/calculated by the UE can be assumed to be reported to the eNB/gNB. The eNB/gNB may forward/report the measured/calculated information to the CN. However, for some information that may not be utilized by the eNB/gNB, the UE may directly report to the CN (e.g., via NAS signaling). The reporting message may be transmitted using a N1 interface. Hence, the UE may support a reporting of assistance information to the CN. The assistance information may comprise at least one of: timing advance (TA) applied at the wireless communication device (e.g., a UE); the ephemeris information applied at the wireless communication device (e.g., for UL pre-compendation); common timing advance (TA) parameters applied at the wireless communication device; a location of the wireless communication device; at least one of a mobility status or a trajectory of the wireless communication device; a measurement of reference signal received power (RSRP) or reference signal received quality (RSRQ) of a serving cell or at least one neighbor cell; time information corresponding to one or more of foregoing information; at least one of a cell identifier (ID) or a beam ID corresponding to one or more of the foregoing information; or a beam ID corresponding to at least one defined measurement result. The TA applied at the UE may be a full TA applied by the UE. The TA applied at the UE can be a sum of a UE-specific service link TA and a common TA. The common TA parameters applied at the UE can be the common TA parameters. The common TA parameters can be used to derive the common TA applied by the UE. The network can derive an accurate UE specific TA applied by the UE, through subtracting the full TA by the common TA (derived using the TA parameters). The motivation is that, in an actual system, the ephemeris may be frequently updated to ensure certain accuracy. The base station may frequently update the broadcast common TA parameters, but the UE may not receive the updated broadcast common TA parameters every time if the old ephemeris information still satisfies the accuracy requirement. As a result, the gNB may not know/be aware of the exact common TA parameters applied by the UE. If the gNB always reports the newest common TA parameters to the CN for positioning, there may be some misalignments which can lead to a positioning error. The at least one defined measurement result can be RTT/Rx-Tx time difference measurements in multi-RTT method, RSTD measurements in DL-time difference of arrival (TDOA) method, or relative time of arrival (RTOA) measurements in UL-TDOA method.

The CN may indicate a trigger/request in a signaling to the UE for the report of above information. The trigger/request may be indicated once or periodically via a certain signaling. The signaling may be indicated through new radio positioning protocol (NRPP) protocol. The NRPP protocol can be a protocol of signaling between a UE and a CN. The trigger signaling may be transmitted via an N1 interface. Another possible way is that a CN indicate a trigger/request in a signaling to an eNB/gNB for request of above information. The eNB/gNB may indicate a trigger/request in a signaling to a UE for reporting above information. In such case, the trigger signaling may be transmitted from the CN to the eNB/gNB via an N2 interface. The eNB/gNB may indicate a trigger signaling to the UE via an Uu interface.

It is worth noting that a UE may report ephemeris information and/or common TA parameters applied by itself, to a CN. The motivation is that an eNB/gNB may not know/be aware of when the UE updates its ephemeris information and common TA parameters. Therefore, the actual ephemeris information and common TA parameters applied by the UE for UL pre-compensation may not be exactly equal to the ones reported from the eNB/gNB to the CN due to a propagation error. Hence, the UE may directly report its applied ephemeris information and/or common TA parameters to the CN.

Moreover, the UE may report at least one location verification measurement result to the eNB/gNB. The eNB/gNB may report the at least one location verification measurement result to the CN. The procedure of report from the UE to the eNB/gNB can be similar to data collection in a self organizing network (SON) and/or minimization of drive test (MDT). In SON/MDT, the UE may report several measurements to the eNB/gNB to help improve the network performance. Hence, the UE may report the measurements for location verification or positioning to the eNB/gNB through similar reports. For example, the measurement results for location verification or positioning can be included in the reporting message designed for SON/MDT (e.g., a report of random access information (e.g., RACH report) or data collection signaling). In certain embodiments, a new signaling, which may be a RRC signaling or MAC CE signaling, can be defined for measurement report for location verification or positioning. After the eNB/gNB collects the measurement results from the UE report, the eNB/gNB may perform location verification at a radio access network (RAN) layer. The eNB/gNB may further report the location verification result to the CN via an NG interface for location verification. In such way, the UE may not be needed to support a positioning feature if only location verification function is needed. Hence, the UE may support a reporting of at least one location verification measurement result for positioning to the eNB/gNB. The at least one location verification measurement result may comprise at least one of: difference in measurements of round-trip times (RTTs) or between receive and transmit (Rx-Tx) times in multi-RTT method; at least one measurement of reference signal time difference (RSTD); at least one measurement of relative time of arrival (RTOA); at least one measurement of reference signal received power (RSRP) or reference signal received quality (RSRQ); an angle of arrival (AoA) or an angle of departure (AoD) at the UE; a timestamp or time information of at least one of foregoing measurements; or at least one of a cell identifier (ID) or a beam ID corresponding to one or more of the foregoing measurements. Moreover, the UE may support a reporting of assistance information for positioning to the eNB/gNB, which comprises at least one of: timing advance (TA) applied at the wireless communication device (e.g., a UE); the ephemeris information applied at the wireless communication device (e.g., for UL pre-compendation); common timing advance (TA) parameters applied at the wireless communication device; a location of the wireless communication device; at least one of a mobility status or a trajectory of the wireless communication device; time information corresponding to one or more of foregoing information; at least one of a cell identifier (ID) or a beam ID corresponding to one or more of the foregoing information; or a beam ID corresponding to at least one defined measurement result.

The eNB/gNB may report above received information to the CN. The report from the UE may be triggered/requested in a signaling by the eNB/gNB. The signaling for the triggering/requesting report may be once or periodically. The trigger/request may be indicated through a radio resource control (RRC) signaling, a medium access control control element (MAC CE) signaling, or a downlink control information (DCI) signaling. Moreover, the trigger/request of above report by the eNB/gNB may be controlled by the CN. The CN may first indicate a trigger/request for above information, and then the eNB/gNB may send trigger/request to the UE for reporting.

Furthermore, a definition of RSTD measurements in DL-TDOA and RTOA measurements in UL-TDOA may be updated compared to a TN positioning. In TN, the RSTD/RTOA measurements may estimate a time difference of arrival times corresponding to different TRPs for same subframe. While in NTN, the RSTD/RTOA may refer/correspond to a time difference between times-of-arrival (TOAs) corresponding to same transmit-receive point (TRP) at different time instances. Moreover, the RSTD/RTOA may refer/correspond to a time difference between times of arrival (TOAs) corresponding to a same transmit-receive point (TRP) at different time instances, minus a time difference between reference signal transmissions. For example, RSTD/RTOA=T_r2−T_r1−delta_T. T_r2 is a receiving time of a second RS. T_r1 is a receiving time of a first RS. delta_T is a time interval between the transmit time of the two RSs (e.g., can be known by configuration). In TN, the two RSs can be transmitted at same time from/to different TRPs. The delta_T=0, and the delay difference to different anchor nodes can be directly calculated by the time difference of arrival. In NTN, the two RSs can be transmitted at different time instances so that delta_T>0. In such case, if the delay difference to different anchor nodes is to be calculated, the transmit time interval can be subtracted from the time difference of arrival. In some embodiments, if the definition of time difference of arrival has considered to minus the transmit time difference into consideration, the RSTD/RTOA may refer/correspond to the time difference between times-of-arrival (TOAs) corresponding to same transmit-receive point (TRP) at different time instances. With this further operation, the RSTD/RTOA can reflect a variation of propagation delay.

It should be understood that one or more features from the above implementation examples are not exclusive to the specific implementation examples, but can be combined in any manner (e.g., in any priority and/or order, concurrently or otherwise).

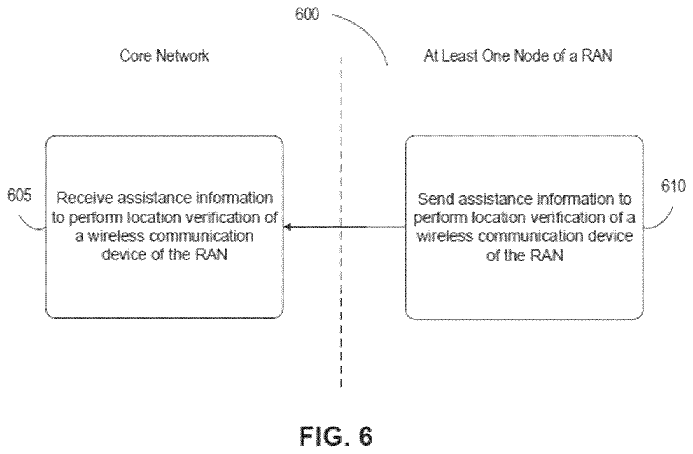

FIG. 6 illustrates a flow diagram for coverage enhancement in non-terrestrial network (NTN), in accordance with an embodiment of the present disclosure. The method 600 may be implemented using any one or more of the components and devices detailed herein in conjunction with FIGS. 1-2. In overview, the method 600 may be performed by a core network, in some embodiments. Additional, fewer, or different operations may be performed in the method 600 depending on the embodiment. At least one aspect of the operations is directed to a system, method, apparatus, or a computer-readable medium.

A core network may receive assistance information from at least one node (e.g., a UE and/or a BS) of a radio access network (RAN), to perform location verification of a wireless communication device (e.g., a UE) of the RAN. In some embodiments, the assistance information may include ephemeris information of a satellite. The core network may perform the location verification of the wireless communication device using the assistance information.

In some embodiments, the at least one node may include a base station. The assistance information may comprise first assistance information. The first assistance information may comprise at least one of: ephemeris information of at least one satellite; common timing advance (TA) parameters of the at least one satellite; at least one of: an angle of arrival (AoA) or an angle of departure (AoD) at the at least one satellite; an estimation of a location of the wireless communication device by the base station; at least one parameter of TA reported by the wireless communication device; assistance information reported by the wireless communication device to the base station, comprising at least one of: the location of the wireless communication device, a mobility status of the wireless communication device, a trajectory of the wireless communication device, a measurement of reference signal received power (RSRP) or reference signal received quality (RSRQ) of a serving cell or at least one neighbor cell, ephemeris information applied at the wireless communication device, or common TA parameters; time information corresponding to one or more of foregoing information; at least one of a cell identifier (ID) or a beam ID corresponding to one or more of the foregoing information; or a beam ID corresponding to at least one defined measurement result.

In some embodiments, the assistance information can be indicated/signaled/sent via a next generation (NG) interface or an N2 interface. The core network may send a signaling to trigger or request reporting of the first assistance information (e.g., send periodically, or once (to trigger a periodic series of reporting)). The signaling can be sent using new radio positioning protocol A (NRPPa) protocol. The signaling can be sent via a next generation (NG) interface or an N2 interface.

In some embodiments, the core network may receive the assistance information reported by the wireless communication device to the base station, in a defined container message from the base station. The at least one node may include the wireless communication device. The assistance information may comprise second assistance information. The second assistance information may comprise at least one of: timing advance (TA) applied at the wireless communication device; the ephemeris information applied at the wireless communication device (e.g., applied for UL pre-compensation); common timing advance (TA) parameters applied at the wireless communication device; a location of the wireless communication device; at least one of a mobility status or a trajectory of the wireless communication device; a measurement of reference signal received power (RSRP) or reference signal received quality (RSRQ) of a serving cell or at least one neighbor cell; time information corresponding to one or more of foregoing information; at least one of a cell identifier (ID) or a beam ID corresponding to one or more of the foregoing information; or a beam ID corresponding to at least one defined measurement result. The assistance information can be indicated via an N1 interface. The core network may send a signaling to trigger or request reporting of the second assistance information to the wireless communication device. The signaling can be sent using new radio positioning protocol (NRPP) protocol. The signaling can be sent via an N1 interface.

In some embodiments, the core network may send a first signaling to trigger or request reporting of the assistance information to the base station. The base station may send a second signaling to the wireless communication device to trigger or request the reporting of the assistance information. The first signaling can be sent via a next generation (NG) interface or an N2 interface. The second signaling can be sent via an Uu interface.

In some embodiments, the at least one node of the RAN may comprise a base station. The wireless communication device may send at least one location verification measurement result to the base station. The core network may receive the at least one location verification measurement result from the base station. The at least one location verification measurement result may form at least a part of the assistance information.

In some embodiments, the at least one location verification measurement result may comprise at least one of: difference in measurements of round-trip times (RTTs) or between receive and transmit (Rx-Tx) times; at least one measurement of reference signal time difference (RSTD); at least one measurement of relative time of arrival (RTOA); a timestamp or time information of at least one of foregoing measurements; or at least one of a cell identifier (ID) or a beam ID corresponding to one or more of the foregoing measurements. The core network may send a first signaling to trigger or request reporting of the at least one defined measurement result to the base station. The core network may cause the base station to send a second signaling to the wireless communication device to trigger or request the reporting of the at least one defined measurement result. The first signaling may comprise at least one of: a radio resource control (RRC) signaling, a medium access control control element (MAC CE) signaling, or a downlink control information (DCI) signaling. The RSTD or the RTOA may correspond to a time difference between times of arrival (TOAs) corresponding to a same transmit-receive point (TRP) at different time instances. The RSTD or the RTOA may correspond to a time difference between times of arrival (TOAs) corresponding to a same transmit-receive point (TRP) at different time instances, minus a time difference between reference signal transmissions.

In some embodiments, at least one node (e.g., a UE and/or a BS) of a radio access network (RAN) may send assistance information to a core network to perform location verification of a wireless communication device (e.g., a UE) of the RAN.

While various embodiments of the present solution have been described above, it should be understood that they have been presented by way of example only, and not by way of limitation. Likewise, the various diagrams may depict an example architectural or configuration, which are provided to enable persons of ordinary skill in the art to understand example features and functions of the present solution. Such persons would understand, however, that the solution is not restricted to the illustrated example architectures or configurations, but can be implemented using a variety of alternative architectures and configurations. Additionally, as would be understood by persons of ordinary skill in the art, one or more features of one embodiment can be combined with one or more features of another embodiment described herein. Thus, the breadth and scope of the present disclosure should not be limited by any of the above-described illustrative embodiments.

It is also understood that any reference to an element herein using a designation such as “first,” “second,” and so forth does not generally limit the quantity or order of those elements. Rather, these designations can be used herein as a convenient means of distinguishing between two or more elements or instances of an element. Thus, a reference to first and second elements does not mean that only two elements can be employed, or that the first element must precede the second element in some manner.

Additionally, a person having ordinary skill in the art would understand that information and signals can be represented using any of a variety of different technologies and techniques. For example, data, instructions, commands, information, signals, bits and symbols, for example, which may be referenced in the above description can be represented by voltages, currents, electromagnetic waves, magnetic fields or particles, optical fields or particles, or any combination thereof.

A person of ordinary skill in the art would further appreciate that any of the various illustrative logical blocks, modules, processors, means, circuits, methods and functions described in connection with the aspects disclosed herein can be implemented by electronic hardware (e.g., a digital implementation, an analog implementation, or a combination of the two), firmware, various forms of program or design code incorporating instructions (which can be referred to herein, for convenience, as “software” or a “software module), or any combination of these techniques. To clearly illustrate this interchangeability of hardware, firmware and software, various illustrative components, blocks, modules, circuits, and steps have been described above generally in terms of their functionality. Whether such functionality is implemented as hardware, firmware or software, or a combination of these techniques, depends upon the particular application and design constraints imposed on the overall system. Skilled artisans can implement the described functionality in various ways for each particular application, but such implementation decisions do not cause a departure from the scope of the present disclosure.

Furthermore, a person of ordinary skill in the art would understand that various illustrative logical blocks, modules, devices, components and circuits described herein can be implemented within or performed by an integrated circuit (IC) that can include a general purpose processor, a digital signal processor (DSP), an application specific integrated circuit (ASIC), a field programmable gate array (FPGA) or other programmable logic device, or any combination thereof. The logical blocks, modules, and circuits can further include antennas and/or transceivers to communicate with various components within the network or within the device. A general purpose processor can be a microprocessor, but in the alternative, the processor can be any conventional processor, controller, or state machine. A processor can also be implemented as a combination of computing devices, e.g., a combination of a DSP and a microprocessor, a plurality of microprocessors, one or more microprocessors in conjunction with a DSP core, or any other suitable configuration to perform the functions described herein.

If implemented in software, the functions can be stored as one or more instructions or code on a computer-readable medium. Thus, the steps of a method or algorithm disclosed herein can be implemented as software stored on a computer-readable medium. Computer-readable media includes both computer storage media and communication media including any medium that can be enabled to transfer a computer program or code from one place to another. A storage media can be any available media that can be accessed by a computer. By way of example, and not limitation, such computer-readable media can include RAM, ROM, EEPROM, CD-ROM or other optical disk storage, magnetic disk storage or other magnetic storage devices, or any other medium that can be used to store desired program code in the form of instructions or data structures and that can be accessed by a computer.

In this document, the term “module” as used herein, refers to software, firmware, hardware, and any combination of these elements for performing the associated functions described herein. Additionally, for purpose of discussion, the various modules are described as discrete modules; however, as would be apparent to one of ordinary skill in the art, two or more modules may be combined to form a single module that performs the associated functions according to embodiments of the present solution.

Additionally, memory or other storage, as well as communication components, may be employed in embodiments of the present solution. It will be appreciated that, for clarity purposes, the above description has described embodiments of the present solution with reference to different functional units and processors. However, it will be apparent that any suitable distribution of functionality between different functional units, processing logic elements or domains may be used without detracting from the present solution. For example, functionality illustrated to be performed by separate processing logic elements, or controllers, may be performed by the same processing logic element, or controller. Hence, references to specific functional units are only references to a suitable means for providing the described functionality, rather than indicative of a strict logical or physical structure or organization.

Various modifications to the embodiments described in this disclosure will be readily apparent to those skilled in the art, and the general principles defined herein can be applied to other embodiments without departing from the scope of this disclosure. Thus, the disclosure is not intended to be limited to the embodiments shown herein, but is to be accorded the widest scope consistent with the novel features and principles disclosed herein, as recited in the claims below.

What is claimed is:

1. A method comprising:
receiving, by a core network, assistance information from at least one node of a radio access network (RAN); and
performing, by the core network, location verification of a wireless communication device of the RAN using the assistance information.

2. The method of claim 1, wherein the at least one node includes a base station, and the assistance information comprises first assistance information, which comprises at least one of:
ephemeris information of at least one satellite;
common timing advance (TA) parameters of the at least one satellite;
at least one of: an angle of arrival (AoA) or an angle of departure (AoD) at the at least one satellite;
an estimation of a location of the wireless communication device by the base station;
at least one parameter of TA reported by the wireless communication device;
assistance information reported by the wireless communication device to the base station, comprising at least one of: the location of the wireless communication device, a mobility status of the wireless communication device, a trajectory of the wireless communication device, a measurement of reference signal received power (RSRP) or reference signal received quality (RSRQ) of a serving cell or at least one neighbor cell, ephemeris information applied at the wireless communication device, or common TA parameters;
time information corresponding to one or more of foregoing information;
at least one of a cell identifier (ID) or a beam ID corresponding to one or more of the foregoing information; or
a beam ID corresponding to at least one defined measurement result.

3. The method of claim 2, wherein the assistance information is indicated via a next generation (NG) interface or an N2 interface.

4. The method of claim 2, comprising:
sending, by the core network to the base station, a signaling to trigger or request reporting of the first assistance information.

5. The method of claim 4, wherein the signaling is sent using new radio positioning protocol A (NRPPa) protocol.

6. The method of claim 4, wherein the signaling is sent via a next generation (NG) interface or an N2 interface.

7. The method of claim 2, wherein:
the core network receives the assistance information reported by the wireless communication device to the base station, in a defined container message from the base station.

8. The method of claim 1, wherein the at least one node includes the wireless communication device, and the assistance information comprises second assistance information, which comprises at least one of:
timing advance (TA) applied at the wireless communication device;
the ephemeris information applied at the wireless communication device;
common timing advance (TA) parameters applied at the wireless communication device;
a location of the wireless communication device;
at least one of a mobility status or a trajectory of the wireless communication device;
a measurement of reference signal received power (RSRP) or reference signal received quality (RSRQ) of a serving cell or at least one neighbor cell;
time information corresponding to one or more of foregoing information;
at least one of a cell identifier (ID) or a beam ID corresponding to one or more of the foregoing information; or
a beam ID corresponding to at least one defined measurement result.

9. The method of claim 8, wherein the assistance information is indicated via an N1 interface.

10. The method of claim 8, comprising:
sending, by the core network to the wireless communication device, a signaling to trigger or request reporting of the second assistance information.

11. The method of claim 10, wherein the signaling is sent using new radio positioning protocol (NRPP) protocol.

12. The method of claim 10, wherein the signaling is sent via an N1 interface.

13. The method of claim 8, comprising:
sending, by the core network to the base station, a first signaling to trigger or request reporting of the assistance information,
wherein the base station sends a second signaling to the wireless communication device to trigger or request the reporting of the assistance information.

14. The method of claim 13, wherein the first signaling is sent via a next generation (NG) interface or an N2 interface, and the second signaling is sent via an Uu interface.

15. The method of claim 1, wherein:
the at least one node of the RAN comprises a base station;
the wireless communication device sends at least one location verification measurement result to the base station; and
the core network receives the at least one location verification measurement result from the base station, the at least one location verification measurement result forming at least a part of the assistance information.

16. The method of claim 15, wherein the at least one location verification measurement result comprises at least one of:
difference in measurements of round-trip times (RTTs) or between receive and transmit (Rx-Tx) times;
at least one measurement of reference signal time difference (RSTD);
at least one measurement of relative time of arrival (RTOA);
a timestamp or time information of at least one of foregoing measurements; or
at least one of a cell identifier (ID) or a beam ID corresponding to one or more of the foregoing measurements.

17. The method of claim 16, comprising at least one of:
sending, by the core network to the base station, a first signaling to trigger or request reporting of the at least one defined measurement result; or
causing the base station to send a second signaling to the wireless communication device to trigger or request the reporting of the at least one defined measurement result.

18. A core network node, comprising:
at least one processor configured to:
receive, via a receiver, assistance information from at least one node of a radio access network (RAN); and
perform location verification of a wireless communication device of the RAN using the assistance information.

19. A method comprising:
sending, by at least one node of a radio access network (RAN), assistance information to a core network; and
causing the core network to perform location verification of a wireless communication device of the RAN, using the assistance information.

20. A at least one node of a radio access network (RAN), comprising:
at least one processor configured to:
send, via a transmitter, assistance information to a core network; and
cause the core network to perform location verification of a wireless communication device of the RAN, using the assistance information.
